(19) United States
(12) Patent Application Publication
(10) Pub. No.: US 2008/0207325 A1
(43) Pub. Date: Aug. 28, 2008

(54) Control arrangement for operating video game console

(76) Inventor: Kent T.J. Hsu, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/711,138

(22) Filed: Feb. 27, 2007

(51) Int. Cl. A63F 13/06

(52) U.S. Cl. 463/39

(57) ABSTRACT

In one embodiment a control arrangement for operating a video game console is disclosed. The arrangement includes a mat having foot panels, a matrix scanning circuit, a peripheral warning track, a MCU, a first transceiver module, a foul line crossing sensor module, and a foul line crossing warning module; a wireless controller including a second transceiver module; and a detector including an oscillation circuit, an ultrasonic transmitter, an ultrasonic receiver, and a warning module adapted to make an audible sound when a distance between a user and an obstacle is less than a safe distance. The foul line crossing warning module is adapted to make an audible sound when the warning track is stepped by the foot.

### BACKGROUND OF THE INVENTION

1. Field of Invention

The invention relates to video game consoles and more particularly to a control arrangement for operating a video game console (e.g., PlayStation 3 (PS3) or Wii) with improved characteristics.

2. Description of Related Art

Video games are widely popular in recent decades. For example, a conventional wireless controller A for video game console PS3 is shown in FIG. 1. The curved controller A comprises a plurality of operating buttons A1, a horizontal direction button A2, and two vertical direction buttons A3. Two hands are required to operate the controller A to play games through PS3. One drawback is that it is difficult of operating the controller A if a sports game is being played through PS3. Another drawback is that the amount of exercise to the lower body is limited.

A wireless controller (i.e., Wii remote) B for video game console Wii is shown in FIG. 2. A plurality of operating buttons B1 and a horizontal direction button B2 are provided on the controller B. Further, an auxiliary controller C for manipulating a vertical direction in certain games is electrically connected to the Wii remote B by a cable (not numbered) as shown. Drawbacks of this type of Wii remote B are detailed below. Two hands are required to hold the Wii remote B and the auxiliary controller C respectively while playing games. It is, however, difficult of operating both the Wii remote B and the auxiliary controller C if a sports game is being played through Wii. Furthermore, the amount of exercise to the lower body is still limited. Thus, the need for improvement still exists.

### SUMMARY OF THE INVENTION

It is therefore one object of the invention to provide a control arrangement for operating a video game console (e.g., PS3 or Wii) in which a warning module is adapted to make an audible sound when a distance between a user and an obstacle (e.g., wall) is less than a safe distance and a foul line crossing warning module is adapted to make an audible sound when a warning track on a mat is stepped by the foot.

The above and other objects, features and advantages of the invention will become apparent from the following detailed description taken with the accompanying drawings.

### BRIEF DESCRIPTION OF THE DRAWINGS

FIG. 1 is a perspective view of a conventional wireless controller for a video game console PS3;

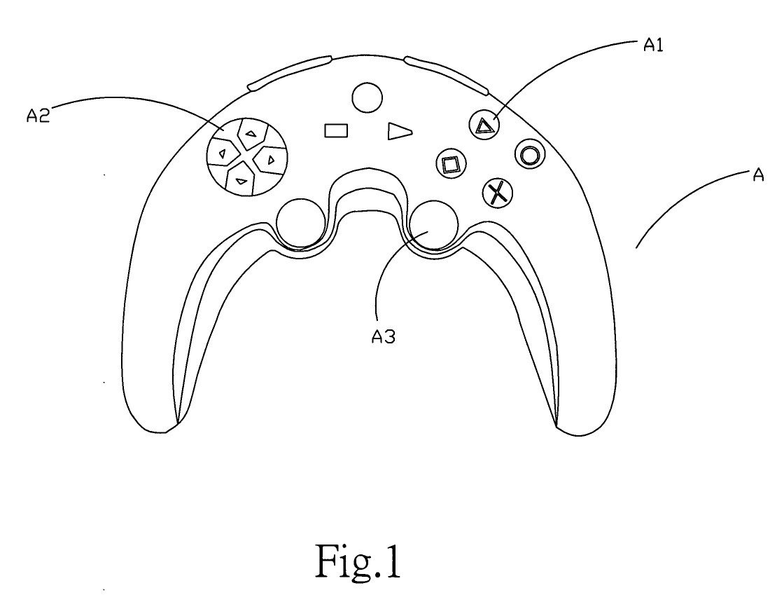

FIG. 2 is a perspective view of a conventional wireless controller for a video game console Wii;

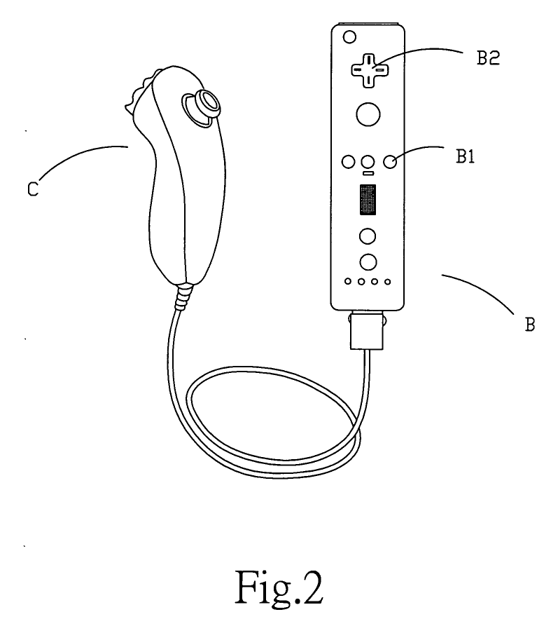

FIG. 3 is a schematic block diagram of two major components of a first preferred embodiment of control arrangement for operating a video game console (e.g., PS3) according to the invention;

FIG. 4 is a schematic perspective view of all three major components of the control arrangement;

FIG. 5 is a top plan view of the mat;

FIG. 6 is an electrical block diagram of the mat;

FIG. 7 is an electrical block diagram of the detector;

FIG. 8 is an environmental view of the control arrangement being operated by a user while playing games through the video game console PS3;

FIG. 9 is a schematic block diagram of three major components of a second preferred embodiment of control arrangement for operating a video game console (e.g., Wii) according to the invention;

FIG. 10 is a schematic perspective view of all four major components of the control arrangement;

FIG. 11 is a schematic block diagram of details of the controller and the wrist band; and

FIG. 12 is an environmental view of the control arrangement being operated by a user while playing games through the video game console Wii.

### DETAILED DESCRIPTION OF THE INVENTION

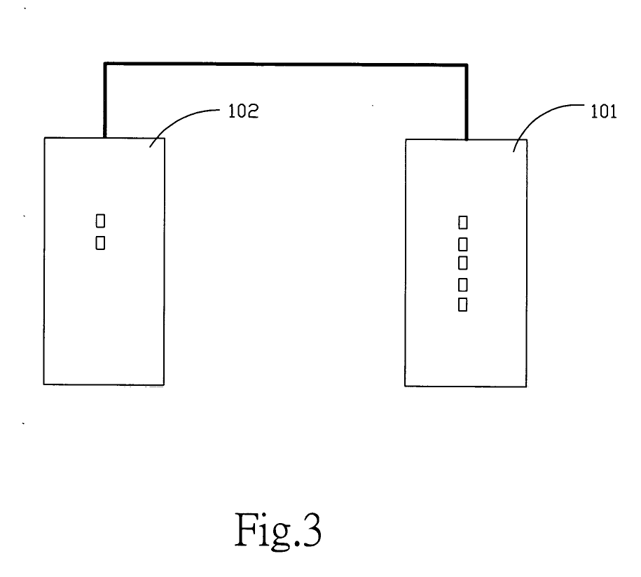

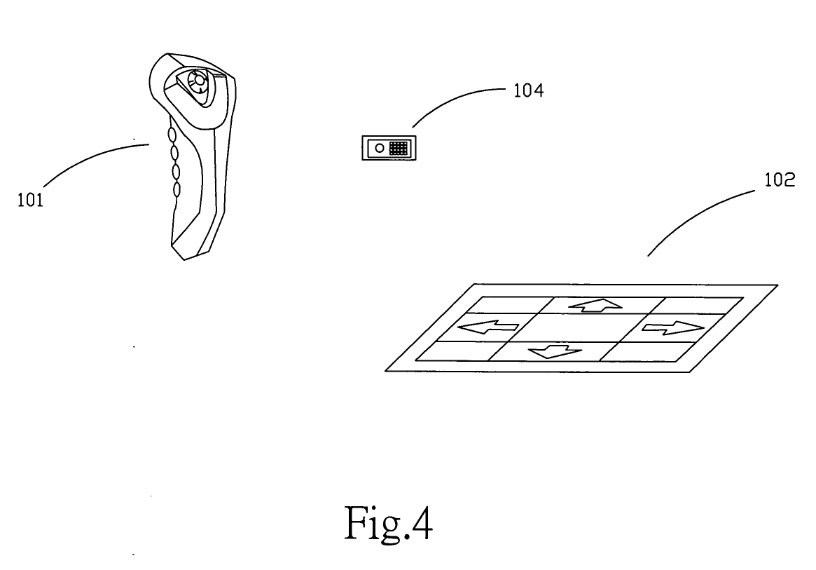

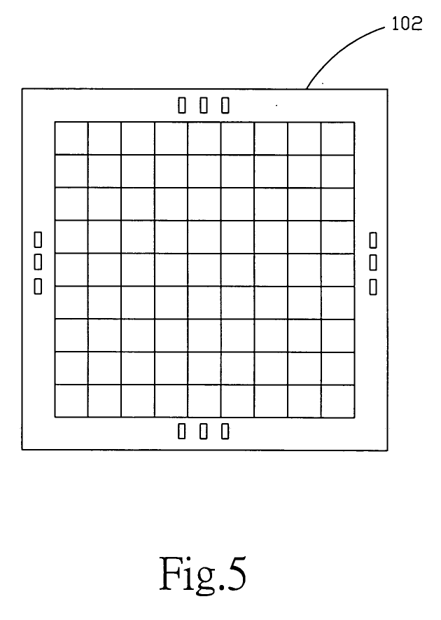

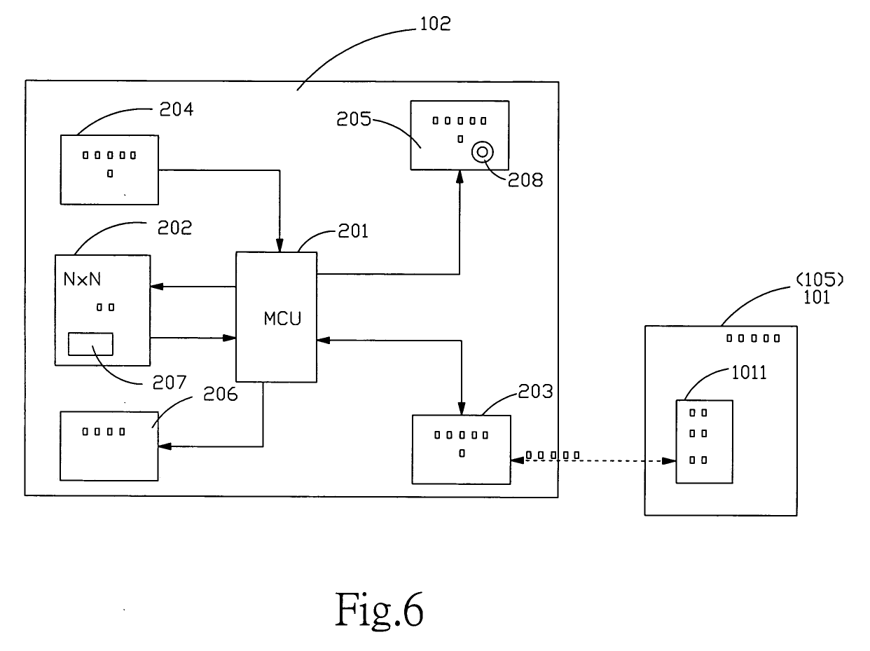

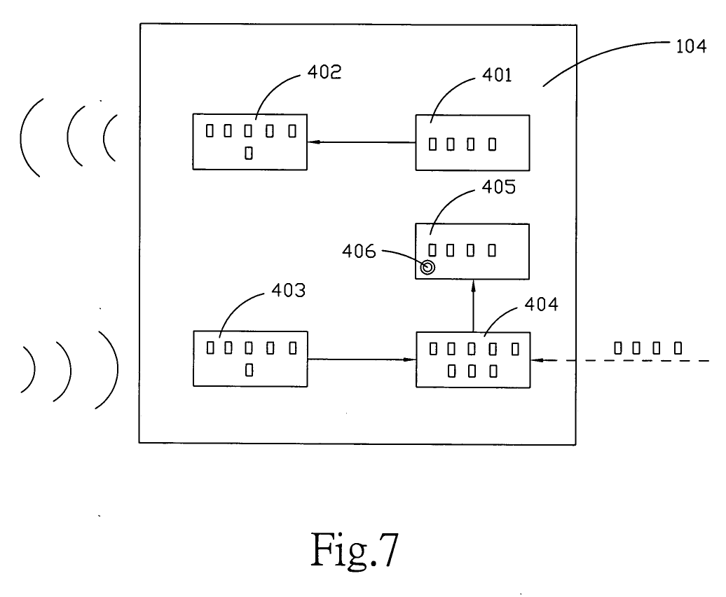

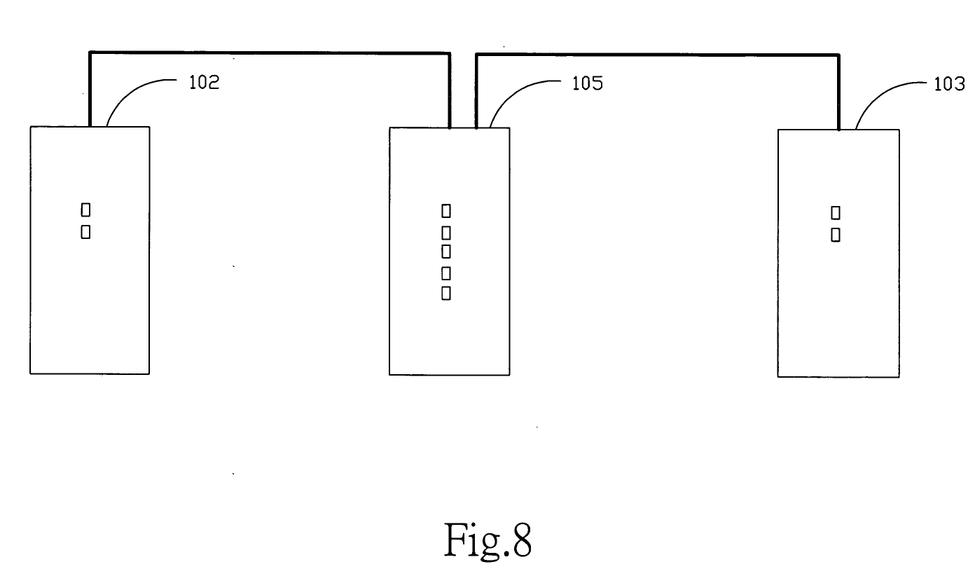

Referring to FIGS. 3 to 8, a control arrangement for operating a video game console (e.g., PS3) in accordance with a first preferred embodiment of the invention is shown. The control arrangement comprises a wireless controller 101, a mat 102, and a detector 104. Each component is discussed in detailed below.

The rectangular mat 102 comprises N×N (e.g., 9×9) square foot panels 202 on a central portion, and a peripheral warning track (not numbered) between the foot panels 202 and an outer edge. The mat 102 further comprises a MCU (micro-control unit) 201, a transceiver module 203, a foul line crossing sensor module 204, and a foul line crossing warning module 205.

There is a matrix scanning circuit 207 provided in the foot panels 202. The matrix scanning circuit 207 is adapted to generate a voltage level signal in response to being stepped by a user. The voltage level signal is then sent to the MCU 201 for determining which foot panel 202 is stepped by the foot. Next, the MCU 201 instructs the transceiver module 203 to send a signal to a transceiver module 1011 of the controller 101 wirelessly or by wire. The foot panel 202 being stepped is shown on a display (not shown) of the controller 101 held by the hand. Further, an integral operation is performed by the controller 101. A warning signal is generated by the foul line crossing sensor module 204 and is sent to the MCU 201 when the foot steps on the warning track. The MCU 201 then sends the warning signal to the foul line crossing warning module 205. The foul line crossing warning module 205 comprises a buzzer 208 which is adapted to audibly warn the user as activated by the foul line crossing warning module 205 in response to receiving the warning signal. Thus, the user is aware that he or she has stepped on the warning track. This is for the safety of a user while playing video games.

The mat 102 further comprises a motor 206 for giving a vibration effect while playing games. For example, in a case of simulating earthquake in the game, the controller 101 instructs the transceiver module 1011 to send a vibration signal to the MCU 201. Next, the MCU 201 activates the motor 206 to vibrate accordingly.

The detector 104 comprises an oscillation circuit 401, an ultrasonic transmitter 402, an ultrasonic receiver 403, a signal amplification circuit 404, and a warning module 405. The oscillation circuit 401 is adapted to generate ultrasonic waves through electromagnetic oscillation. Next, the ultrasonic transmitter 402 transmits the ultrasonic waves which are to be reflected by an obstacle (e.g., wall). The ultrasonic receiver 403 receives the reflected ultrasonic waves. Thus, it is possible of determining a distance between a user wearing the detector 104 on the waist and the obstacle by calculating a time difference between the transmission and the receiving. Thus, a user can enable the signal amplification circuit 404 to set a safe distance before playing games. The warning module 405 comprises a buzzer 406 which is adapted to make a buzzing sound as warning when a distance between a user and an obstacle is less than the safety distance.

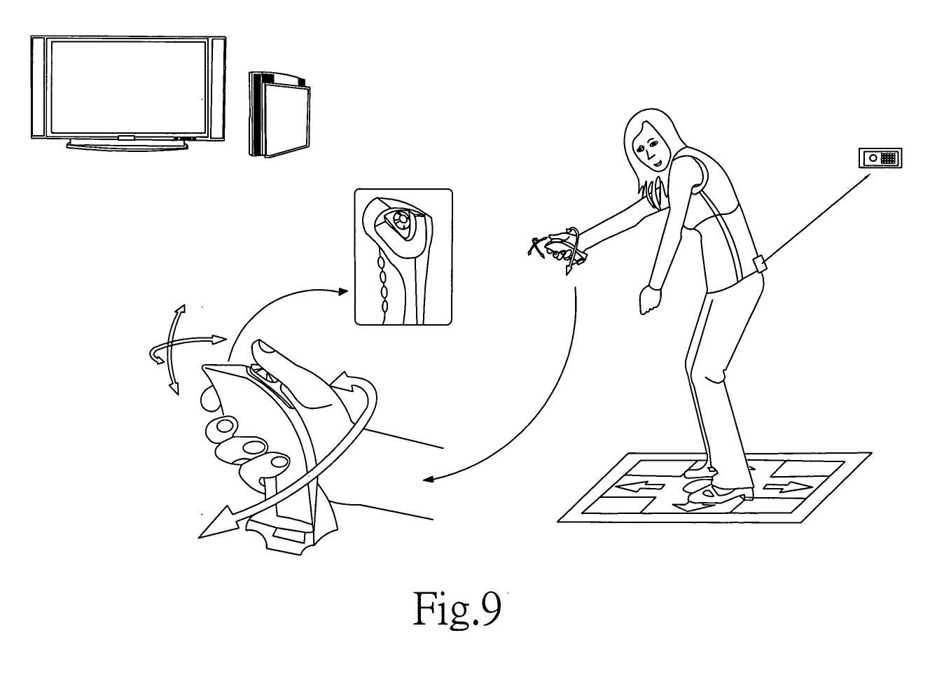

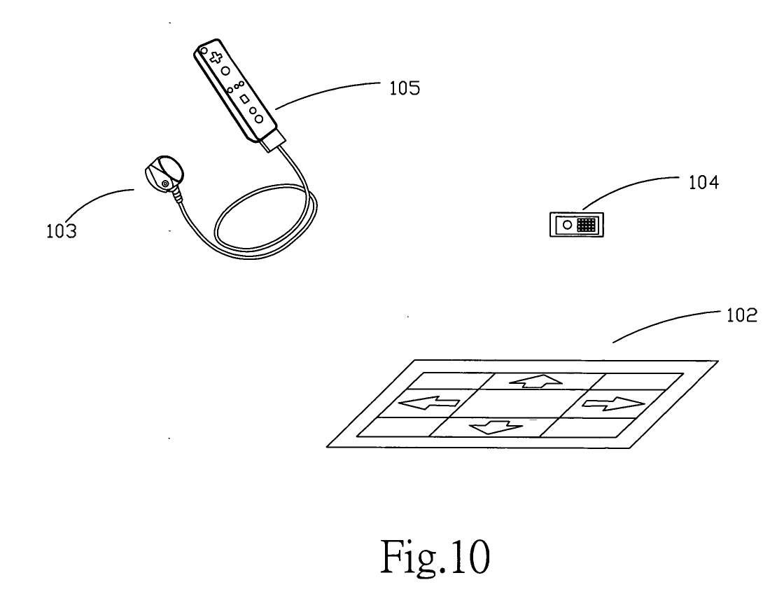

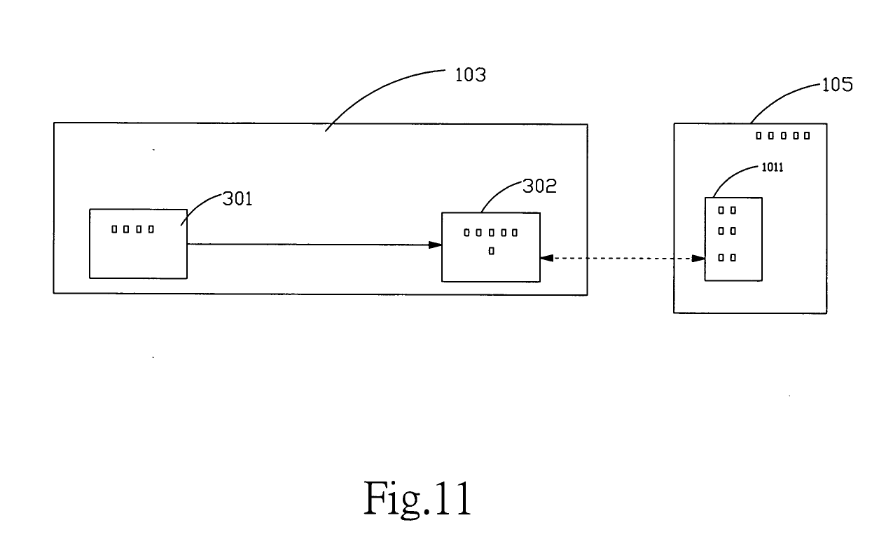

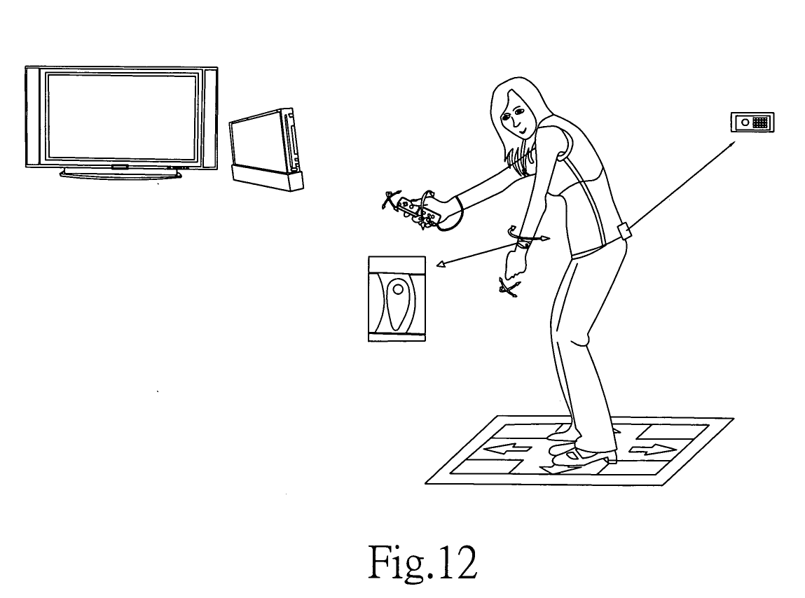

Referring to FIGS. 9 to 12, a control arrangement for operating a video game console (e.g., Wii) in accordance with a second preferred embodiment of the invention is shown. The control arrangement comprises a wireless controller 105, a mat 102, a detector 104, and a wrist band 103.

The mat 102, the controller 105 and the detector 104 are identical to that described in the first embodiment. Thus, a detailed description thereof is therefore deemed unnecessary.

The wrist band 103 as the characteristics of the second preferred embodiment is detailed below. The wrist band 103 is wrapped around the wrist and is electrically connected to the controller 105 by wire. The wrist band 103 comprises a sensor module 301 for sensing motion of the hand, and a transceiver module 302 for, in one operation, sending a signal to a transceiver module 1011 of the controller 105 or receiving a signal therefrom by wire. Note that wrist band 103 can be implemented as a wireless one in the other embodiment. Thus, signal communications between the wrist band 103 and the controller 105 is made wireless. The second embodiment can further increase excitement while playing games through Wii.

While the invention herein disclosed has been described by means of specific embodiments, numerous modifications and variations could be made thereto by those skilled in the art without departing from the scope and spirit of the invention set forth in the claims.

What is claimed is:

1. A control apparatus for operating a video game console comprising:
a mat comprising a plurality of foot panels arranged as a matrix on a central portion, a matrix scanning circuit, a peripheral warning track between the foot panels and an outer edge, a MCU (micro-control unit), a first transceiver module, a foul line crossing sensor module, and a foul line crossing warning module including a first buzzer;
wireless control means adapted to be held by the hand and including a display, a plurality of buttons, and a second transceiver module; and
detector means comprising an oscillation circuit, an ultrasonic transmitter, an ultrasonic receiver, a signal amplification circuit for setting a predetermined safe distance, and a warning module including a second buzzer,
wherein in response to activating the control means the oscillation circuit is adapted to generate ultrasonic waves, the ultrasonic transmitter transmits the ultrasonic waves to be reflected by an obstacle, the ultrasonic receiver receives the reflected ultrasonic waves for determining whether a distance between a user wearing the detector means and the obstacle by calculating a time difference between the transmission and the receiving, and the second buzzer is adapted to make a buzzing sound when the distance between the user and the obstacle is less than the predetermined safe distance; and
the matrix scanning circuit is adapted to generate a voltage level signal in response to one of the foot panels being stepped by the user, the voltage level signal is sent to the MCU for determining which foot panel is stepped by the foot, the MCU instructs the first transceiver module to send a signal to the second transceiver module which is adapted to convert the signal into an indication value representing the foot panel being stepped on the display, the control means is adapted to perform an operation so that the foul line crossing sensor module is adapted to enable to generate and send a warning signal to the MCU when the foot steps on the warning track, and the MCU sends the warning signal to the foul line crossing warning module which is adapted to activate the first buzzer to make a buzzing sound when the warning track is stepped by the foot.

2. The control apparatus of claim 1, wherein the mat further comprises a motor, and wherein the control means is adapted to instruct the second transceiver module to send a vibration signal to the MCU via the first transceiver module so that the motor is adapted to vibrate in response to being instructed by the MCU.

3. The control apparatus of claim 1, further comprising a wrist band adapted to wrap around the wrist, the wrist band comprising a sensor element for sensing motion of the hand, and a third transceiver module for communicating signal with the second transceiver module.

4. The control apparatus of claim 3, wherein the wrist band and the control means are electrically connected together.

5. The control apparatus of claim 3, wherein the wrist band is a wireless wrist band.
